(19) United States
(12) Patent Application Publication
(10) Pub. No.: US 2001/0017837 A1
(43) Pub. Date: Aug. 30, 2001

(54) Method and device for reproducing information from an optical recording medium and an optical recording medium

(76) Inventor: Kazuyuki Ogura, Higashiosaka-Shi (JP)

Correspondence Address: SIDLEY AUSTIN BROWN & WOOD, 717 NORTH HARWOOD, SUITE 3400, DALLAS, TX, 75201, US

(21) Appl. No.: 09/776,193

(22) Filed: Feb. 2, 2001

(30) Foreign Application Priority Data
Feb. 2, 2000 (JP) 2000-25112

(51) Int. Cl. G11B 7/00

(52) U.S. Cl. 369/108

(57) ABSTRACT

A method and device for reproducing information from an optical recording medium having a recording layer containing a photochromic material for recording information and an optical recording medium, the method, device and medium being capable of utilizing the conventional method which reproduces information based on the amount of reflected light from the recording layer by irradiation of the recording layer with information-reproducing light, and being capable of reproducing information without destruction of the information recorded on the recording layer.

This invention is based on patent application No. 2000-25112 Pat. filed in Japan, the contents of which are hereby incorporated by reference.

### BACKGROUND OF THE INVENTION

1. Field of the Invention

The present invention relates to a method and device for reproducing information from an optical recording medium having a recording layer containing a photochromic material for recording information.

The present invention also concerns with an optical recording medium to be used for the method and device.

2. Description of the Background Art

Of optical recording media, an optical recording medium is available which is capable of erasing the information recorded on the medium and re-writing the information.

Optical recording media capable of re-writing information include photochromic media utilizing the photochromic reaction of a photochromic material. The foregoing photochromic media belong to photon-mode recording media having a recording layer which directly undergoes a change of recording on absorption of photon.

The photochromic reaction is reversible as described below. When a photochromic material in a state of ring cleavage is irradiated with light of λ1 in wavelength which is absorbed in the photochromic material in a state of ring cleavage, the photochromic material attains a state of ring closure in which light of different wavelength is absorbed, but the photochromic material in a state of ring closure reverts to the original state of ring cleavage when irradiated with light of λ2 in wavelength which is absorbed in the material in a state of ring closure. A photochromic medium intended to utilize the photochromic reaction is useful as an optical recording medium capable of re-writing information when it is used in such a way that any one of ring cleavage and ring closure states is made to correspond with an information-unrecorded state (a state wherein information is not recorded) or with an information-recorded state (a state wherein information is recorded)

The photochromic medium usually has a recording layer containing a photochromic material for recording information. The recording layer containing a photochromic material is irradiated with light to record information on the photochromic medium, to reproduce (read) information from the photochromic medium or to erase information on the photochromic medium.

When information is recorded or reproduced using the photochromic medium, information can be accurately recorded and reproduced by conducting tracking servo for tracking control and focusing servo for focusing control.

Information is reproduced from the photochromic medium usually by detecting a variation in the intensity of reflected light from the recording layer by irradiating the recording layer of the medium with information-reproducing light, the variation being caused by a difference in light absorptivity between the information-recorded area and the information-unrecorded area, or in other words, by detecting a variation in the amount of reflected light from the recording layer. In this case, the information-reproducing light used has a wavelength in the region which is absorbed in the photochromic material.

In a photon-mode recording medium such as a photochromic medium, the recorded information may be changed by an operation of the reproduction of information (e.g. the information recorded on the recording layer may be destroyed) even when the recording layer is irradiated with low-intensity information-reproducing light. This is because a threshold value is not defined for a change in recording of information. Such destruction of recorded information by reproduction of information is, of course, undesirable, and non-destructive reproduction of information should be realized.

Methods have been proposed for non-destructive reproduction of information from the photochromic medium. The proposals are roughly classified into three methods: (1) a method wherein a threshold value is defined for a change in recording of information; (2) a method wherein information is reproduced using light by which information is not recorded; and (3) a method wherein the recorded state of information is fixed.

Of these methods, reference is made to the method (2) wherein information is reproduced using light by which information is not recorded. Japanese Examined Patent Publication No.2792872 discloses a method wherein information is reproduced from the optical recording medium having a recording layer containing a photochromic material by detecting a variation in the refractive index of the recording layer having recorded information by irradiating the recording layer with light of wavelength which is substantially not absorbed in the recording layer.

However, the information-reproducing method of Japanese Examined Patent Publication No.2792872 is adapted to reproduce information by detecting, as a phase difference, a variation in the refractive index of the recording layer containing a photochromic material, so that it is impossible to use the conventional means for reproducing information by detecting a variation in the amount of reflected light from the recording layer. Namely the disclosed method is improper in conformability with the conventional information-reproducing method.

When tracking servo or focusing servo is conducted in recording or reproducing information on or from a photochromic medium, generally the recording layer of the photochromic medium is continuously irradiated with light for tracking servo or focusing servo. If light of a wavelength absorbable by the photochromic material is used as the light for servo as done in the foregoing reproduction of information, there arises a problem that the information recorded on the recording layer may be destroyed.

### SUMMARY OF THE INVENTION

It is an object of the present invention to provide basically a method and device for reproducing information from an optical recording medium having a recording layer containing a photochromic material for recording information, and to provide an optical recording medium having a recording layer containing a photochromic material for recording information.

Stated more specifically, an object of the invention is to provide a method for reproducing information from an optical recording medium having a recording layer containing a photochromic material for recording information, the method being capable of utilizing the conventional method which reproduces information based on the amount of reflected light from the recording layer by irradiation of the recording layer with information-reproducing light, and the method also being capable of reproducing information without destruction of the information recorded on the recording layer.

Another object of the invention is to provide a device for reproducing information from an optical recording medium having a recording layer containing a photochromic material for recording information, the device being capable of utilizing the conventional method which reproduces information based on the amount of reflected light from the recording layer by irradiation of the recording layer with information-reproducing light, and the device also being capable of reproducing information without destruction of the information recorded on the recording layer.

A further object of the invention is to provide an optical recording medium having a recording layer containing a photochromic material for recording information, the optical recording medium making it possible to utilize the conventional method which reproduces information based on the amount of reflected light from the recording layer by irradiation of the recording layer with information-reproducing light and also making it possible to reproduce information without destruction of the information recorded on the recording layer.

A still further object of the invention is to provide a method for reproducing information from an optical recording medium having a recording layer containing a photochromic material for recording information, the method enabling tracking servo and/or focusing servo without destruction of the information recorded on the recording layer.

An additional object of the invention is to provide a device for reproducing information from an optical recording medium having a recording layer containing a photochromic material for recording information, the device enabling tracking servo and/or focusing servo without destruction of the information recorded on the recording layer.

The present inventor conducted extensive research to achieve the foregoing objects and found the following.

When use is made of an optical recording medium having a recording layer containing a photochromic material for recording information, the refractive index of the recording layer widely varies between the information-recorded state and the information-unrecorded state with respect to light in the region of wavelength which is on the terminal of long wavelength side of light absorption terminals in light absorption spectrum of the recording layer, and substantially not absorbed in the recording layer.

When the refractive index of the recording layer is varied, a variation is made in the state of interference between reflected light at an interface on the light-irradiated side of the recording layer and reflected light at an interface on the side opposed to the light-irradiated side thereof, whereby a difference is brought about in the amount of reflected light therefrom depending on whether the recording layer is in the information-recorded state or the information-unrecorded state when the recording layer is irradiated with information-reproducing light. Information can be reproduced by utilizing the difference in the amount of reflected light.

When use is made of an optical recording medium having a recording layer containing a photochromic material for recording information, the recording layer is irradiated with light in the region of wavelength which is substantially not absorbed in the recording layer, namely as the information-reproducing light, whereby the information recorded on the recording layer due to a variation of refractive index can be reproduced according to a variation in the amount of reflected light from the recording layer. In this case, the information can be reproduced without destruction of the information since the light in the region of wavelength which is substantially not absorbed in the recording layer is used as the information-reproducing light.

According to the research by the present inventor, the optical recording medium having the recording layer containing a photochromic material for recording information is such that the reflectance in each of the information-recorded state and the information-unrecorded state is variable according to a variation in the thickness of the recording layer. Consequently the difference of reflectance between the information-recorded state and the information-unrecorded state depends on the thickness of the recording layer. The reflectance is variable according to the thickness of the recording layer due to effect of interference by multiple reflection. When the recording layer is irradiated with information-reproducing light, interference occurs between reflected light from an interface on the information-reproducing light-irradiated side of the recording layer and reflected light from an interface on the side opposed to the light-irradiated side. The larger the amount of reflected light from the interface on the information-reproducing light-irradiated side of the recording layer and the amount of reflected light from the interface on the side opposed to the light-irradiated side, the greater the difference in reflectance between the information-unrecorded state and the information-recorded state. Accordingly, when the thickness of the recording layer is in a specific range wherein the greatest or substantially greatest difference is made between the amount of reflected light from the recording layer by irradiation of the medium with information-reproducing light and the amount of reflected light from the medium wherein no recording layer is present by irradiation of the medium with information-reproducing light, due to interference occurring between reflected light from the interface on the information-reproducing light-irradiated side of the recording layer and reflected light from the interface on the side opposed to the light-irradiated side, a significant difference is brought about in the reflectance between the information-unrecorded state and the information-recorded state, whereby the information is reproduced more easily and more precisely.

In an optical recording medium having a recording layer containing a photochromic material for recording information, a great difference can be made in the amount of reflected light between the information-unrecorded state and the information-recorded state by forming an interference layer which is substantially transparent with respect to the information-reproducing light emitted to the recording layer, the interference layer having a thickness of approximately λ(2 m−1)/(4n) wherein λ is the wavelength of information-reproducing light, m is an optional integer of 1 or more and n is the refractive index of the interference layer, the interference layer being provided in a position adjacent to at least one of the interface on the information-reproducing light-irradiated side of the recording layer and the interface on the side opposed to the light-irradiated side.

The present invention was completed based on these novel findings. According to the present invention, there are provided the following method and device for reproducing information and first and second optical recording media.

(1) Method for reproducing information from an optical recording medium

A method for reproducing information from an optical recording medium, the method comprising the steps of:

providing an optical recording medium having a recording layer containing a photochromic material on which information can be recorded due to a variation in an optical property(e.g., a variation in refractive index) of the photochromic material,

irradiating the optical recording medium with information-reproducing light in the region of wavelength which is substantially not absorbed in the recording layer, and

reproducing information based on the result of detecting the amount of the information-reproducing light reflected from the optical recording medium.

(2) Device for reproducing information from an optical recording medium

A device for reproducing information from an optical recording medium, the device comprising:

a portion for accommodating an optical recording medium having a recording layer containing a photochromic material on which information can be recorded due to a variation in an optical property(e.g., a variation in refractive index) of the photochromic material,

an information-reproducing light source for emitting information-reproducing light in the region of wavelength which is substantially not absorbed in the recording layer,

an optical system for reproducing information which is adapted to irradiate with the information-reproducing light the optical recording medium accommodated in the optical recording medium-accommodating portion, and

an information reading device for reproducing information based on the result of detecting the amount of the information-reproducing light reflected from the optical recording medium.

(3) First optical recording medium

An optical recording medium having a recording layer containing a photochromic material for recording information, wherein a thickness of the recording layer is in a specific range such that the greatest or substantially greatest difference is made between the amount of reflected light from the recording layer by irradiating the medium with information-reproducing light and the amount of reflected light from the medium wherein the recording layer is not present by irradiation of the medium without the recording layer with the information-reproducing light, due to interference occurring between reflected light from an interface on the information-reproducing light-irradiated side of the recording layer and reflected light from an interface on the side opposed to the light-irradiated side.

(4) Second optical recording medium

An optical recording medium having a recording layer containing a photochromic material for recording information, wherein an interference layer is provided, and the interference layer is substantially transparent with respect to information-reproducing light emitted to the recording layer, the interference layer having a thickness of approximately λ(2 m−1)/(4n) wherein λ is the wavelength of the information-reproducing light, m is an optional integer of 1 or more and n is the refractive index of the interference layer, and the interference layer being formed in a position adjacent to at least one of an interface on the information-reproducing light-irradiated side of the recording layer and an interface on the side opposed to the light-irradiated side.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows the structure of an apparatus for recording, reproducing and erasing information which includes an example of the information-reproducing device for carrying out the method for reproducing information from the optical recording medium wherein an example of the optical recording medium is accommodated.

FIG. 2 is a schematic section view partly showing the optical recording medium and shows the state of reflected light from the optical recording medium by irradiation of the medium with information-reproducing light.

FIG. 3 (A) shows the chemical formula of the photochromic material in the state of ring cleavage to be used for the recording layer of the optical recording medium shown in FIG. 2, and FIG. 3 (B) is a graph showing the absorption intensity (light absorption spectrum) of the photochromic material used for the recording layer in the state of ring cleavage (information-recorded state) and in the state of ring closure (information-unrecorded state) with respect to the wavelength of light.

FIG. 4 shows a modification of the apparatus for recording, reproducing and erasing information which is shown in FIG. 1.

FIG. 5 is a schematic section view partly showing a modification of the optical recording medium and shows the state of reflected light from the optical recording medium by irradiation of the medium with information-reproducing light.

FIG. 6 is a graph showing the dependence, on the thickness of the recording layer, of a difference in the reflectance between the information-recorded state and the information-unrecorded state of the recording layer by irradiation of the recording layer with information-reproducing light when a first interference layer and a second interference layer both have a thickness of λ/(4n) or λ/(2n)

FIG. 7 (A) shows a photochromic medium having an interference layer provided only at the interface on the information-reproducing light-irradiated side of the recording layer, and FIG. 7 (B) shows a photochromic medium having an interference layer provided only at the interface on the side opposed to the information-reproducing light-irradiated side of the recording layer.

FIG. 8 is a schematic section view partly showing a further modification of the optical recording medium.

FIG. 9 shows another modification of the apparatus for recording, reproducing and erasing information which is shown in FIG. 1.

FIG. 10 shows another modification of the apparatus for recording, reproducing and erasing information which is shown in FIG. 4.

FIG. 11 is a graph showing the experimental results of Experiment Example 1.

### DESCRIPTION OF THE PREFERRED EMBODIMENTS

Preferred embodiments of the present invention include the following method and device for reproducing information and first and second optical recording media.

(1) Method for reproducing information from an optical recording medium

An optical recording medium is prepared. The medium has a recording layer containing a photochromic material on which information can be recorded due to a variation in the refractive index of the photochromic material.

The optical recording medium is irradiated with information-reproducing light in the region of wavelength which is substantially not absorbed in the recording layer.

The information is reproduced based on the result of detecting the amount of the information-reproducing light reflected from the optical recording medium.

(2) Device for reproducing information from an optical recording medium

The device for reproducing information from an optical recording medium comprises a portion for accommodating an optical recording medium, an information-reproducing light source, an optical system for reproducing information and an information reading device.

The portion accommodates the optical recording medium which has a recording layer containing a photochromic material on which information can be recorded due to a variation in the refractive index of the photochromic material.

The information-reproducing light source emits information-reproducing light in the region of wavelength which is substantially not absorbed in the recording layer.

The optical system is adapted to irradiate with the information-reproducing light the optical recording medium accommodated in the optical recording medium-accommodating portion.

The information reading device reproduces information based on the result of detecting the amount of the information-reproducing light reflected from the optical recording medium.

(3) First optical recording medium

The optical recording medium has a recording layer containing a photochromic material for recording information. The thickness of the recording layer is in a specific range such that the greatest or substantially greatest difference is made between the amount of reflected light from the recording layer by irradiating the medium with information-reproducing light and the amount of reflected light from the medium wherein the recording layer is not present by irradiation of the medium without the recording layer with the information-reproducing light, due to interference occurring between reflected light from an interface on the information-reproducing light-irradiated side of the recording layer and reflected light from an interface on the side opposed to the light-irradiated side.

(4) Second optical recording medium

The optical recording medium has a recording layer containing a photochromic material for recording information.

In the medium, an interference layer is provided and the interference layer is substantially transparent with respect to information-reproducing light emitted to the recording layer. The interference layer has a thickness of approximately λ(2 m−1)/(4n) wherein λ is the wavelength of the information-reproducing light, m is an optional integer of 1 or more and n is the refractive index of the interference layer. The interference layer is formed in a position adjacent to at least one of an interface on the information-reproducing light-irradiated side of the recording layer and an interface on the side opposed to the light-irradiated side.

The first and second optical recording media each have the recording layer containing the photochromic material for recording information and are capable of rewriting information when the media are used in such a way that any one of ring cleavage state and ring closure state of the photochromic material in the recording layer is caused to correspond with an information-unrecorded state (a state wherein information is not recorded) or with an information-recorded state (a state wherein information is recorded).

In the first optical recording medium, the thickness of the recording layer is in a range wherein the greatest or substantially greatest difference is made between the amount of reflected light from the recording layer by irradiation of the recording medium with the information-reproducing light and the amount of reflected light from the medium lacking the recording layer by the same light irradiation, due to interference occurring between reflected light from the interface on the information-reproducing light-irradiated side of the recording layer and reflected light from the interface on the side opposed to the light-irradiated side.

The second optical recording medium has the interference layer which is substantially transparent with respect to the information-reproducing light emitted to the recording layer, the interference layer having the thickness of approximately λ(2 m−1)/(4n) wherein λ is the wavelength of the information-reproducing light, m is an optional integer of 1 or more and n is the refractive index of the interference layer, and the interference layer being formed in the position adjacent to at least one of the interface on the information-reproducing light-irradiated side of the recording layer and the interface on the side opposed to the light-irradiated side.

In the first and second optical recording media, the more the amount of reflected light from the interface on the information-reproducing light-irradiated side of the recording layer and the amount of reflected light from the interface on the side opposed to the light-irradiated side, the greater the difference in reflectance between the information-unrecorded state and the information-recorded state.

At any event, the first and second optical recording media are accommodated in the information-reproducing device and are used for conducting the information-reproducing method.

In the method for reproducing information from the optical recording medium, the optical recording medium is provided on which information can be recorded due to a variation in the refractive index of the photochromic material in the recording layer, and the optical recording medium is irradiated with, as the information-reproducing light, light in the region of wavelength which is substantially not absorbed in the recording layer. Then, information is reproduced based on the result of detecting the amount of information-reproducing light reflected from the optical recording medium. Thus, the information recorded on the recording layer of the optical recording medium based on a variation in the refractive index of the photochromic material can be reproduced based on a variation in the amount of reflected light from the recording layer on irradiation of the recording layer with, as the information-reproducing light, the light in the region of wavelength which is substantially not absorbed in the recording layer.

In the device for reproducing information from the optical recording medium, in order to reproduce information from the optical recording medium having a recording layer containing a photochromic material on which information can be recorded due to a variation in the refractive index of the photochromic material, the light in the region of wavelength which is substantially not absorbed in the recording layer is emitted as the information-reproducing light from the information-reproducing light source to the optical recording medium accommodated in the optical recording medium-accommodating portion via the information-reproducing optical system. Then the information is reproduced based on the result of detecting the amount of the information-reproducing light reflected from the optical recording medium by the information reading device. In this way, the information recorded on the recording layer due to a variation in the refractive index can be read with the information reading device based on a variation in the amount of reflected light from the recording layer by irradiation of the recording layer with the information-reproducing light emitted from the information-reproducing light source via the information-reproducing optical system to the recording layer.

According to the method and device for reproducing information from the optical recording medium using the first and second optical recording media, the information recorded on the recording layer is not destroyed since the information is reproduced using the light in the region of wavelength which is substantially not absorbed in the recording layer as the information-reproducing light. Further, because the information recorded on the recording layer due to a variation in the refractive index is reproduced based on a variation in the amount of reflected light from the recording layer, the method and device are proper in conformability with the conventional information-reproducing method. As described above, the method and device of the invention can utilize the conventional information-reproducing systems adapted to reproduce information based on the amount of reflected light from the recording layer by irradiation with information-reproducing light, and above all, can reproduce information without destruction of the information recorded on the recording layer.

Furthermore, according to the first optical recording medium, the thickness of the recording layer is in a specific range wherein the greatest or substantially greatest difference is brought about between the amount of reflected light from the recording layer by irradiation of the medium with the information-reproducing light and the amount of reflected light from the recording medium in which the recording layer is absent by irradiation of the medium with the same light, due to interference occurring between reflected light from the interface on the information-reproducing light-irradiated side of the recording layer and reflected light from the interface on the side opposed to the light-irradiated side. Accordingly it is possible to provide a larger amount of reflected light from the interface on the information-reproducing light-irradiated side of the recording layer and a larger amount of reflected light from the interface on the side opposed to the light-irradiated side, with the result that a correspondingly great difference can be made in reflectance between the information-unrecorded state and the information-recorded state.

According to the second optical recording medium, a greater difference in the amount of reflected light can be made between the information-recorded state and the information-unrecorded state of the recording layer when the interference layer is provided which is substantially transparent with respect to the information-reproducing light, the interference layer having the thickness of approximately λ(2 m−1)/(4n) wherein λ is the wavelength of the information-reproducing light, m is an optional integer of 1 or more and n is the refractive index of the interference layer, and the interference layer being formed in the position adjacent to at least one of the interface on the information-reproducing light-irradiated side of the recording layer and the interface on the side opposed to the light-irradiated side.

In the second optical recording medium, the interference layer may be formed in the positions adjacent to both interfaces of the recording layer. Alternatively the interference layer may be formed in the position adjacent to any one of the interfaces of the recording layer and a metallic layer may be provided in the position adjacent to the interface on the side on which the interference layer is not formed. Thereby a greater difference can be made in the amount of reflected light between the information-recorded state and the information-unrecorded state of the recording layer than when the interference layer is provided in the position adjacent to only any one of the interfaces on the recording layer.

As described above, the more the amount of reflected light from the interface on the information-reproducing light-irradiated side of the recording layer and the amount of reflected light from the interface on the side opposed to the light-irradiated side, the greater the difference in reflectance between the information-unrecorded state and the information-recorded state. From this viewpoint, a preferred interference layer is one widely differing in the refractive index from the recording layer and is therefore one formed from a material of high refractive index, e.g. at least one material selected from TiO₂, ZrO₂, ZnS, PbCl₂, Ta₂O₅, SiN, DLC (diamond like carbon), SiC, GaP, SiGe and GaAs to which, however, the material is not limited. Alternatively a material of low refractive index such as MgF₂ and Na₃AlF₆ which is as low as about 1.3 in refractive index can also be used as the material for the interference layer. The interference layer can be formed by, e.g. a sputtering method.

Examples of materials for the metallic layer are metals, alloys, metallic compounds and the like. Specific examples include aluminum (Al), gold (Au), silver (Ag), copper (Cu) and like metals and Al alloys. The metallic layer can be formed by, e.g. a sputtering method, a vacuum vapour deposition method or the like.

At any rate, materials for the recording layer containing the photochromic material in each of the first and second optical recording media include, for example, a spiropyran compound, a diarylethene compound and like photochromic material. The recording layer can be formed by, e.g. a vacuum vapour deposition method, spin coating method or the like.

Any of the first and second optical recording media may contain a base plate formed from, e.g. glass, resin or the like. Examples of useful resin are acrylic resins, methacrylic resins, polycarbonate resins and the like.

In the method for reproducing information from the optical recording medium, tracking servo-control for tracking control and/or focusing servo-control for focusing control can be conducted. The information recorded on the recording layer can be prevented from breakdown in tracking servo and/or focusing servo process by conducting tracking servo-control and/or focusing servo-control using the information-reproducing light as the light for tracking servo-control and/or focusing servo-control. Consequently, it is possible to effect tracking and/or focusing without breakdown of the information recorded on the recording layer.

The devices for reproducing information from the optical recording medium may include a servo device for performing tracking servo-control and/or focusing servo-control using light which is emitted from the same light source as the information-reproducing light source and which is substantially not absorbed in the recording layer, namely as the light for tracking servo-control and/or focusing servo-control when the information recorded on the recording layer of the optical recording medium due to a variation of the refractive index is reproduced based on a variation in the amount of reflected light from the recording layer by irradiating the recording layer with the information-reproducing light emitted from the information-reproducing light source via the information-reproducing optical system.

According to the foregoing information-reproducing device, the servo device is adapted to perform tracking servo-control and/or focusing servo-control using the light in the region of wavelength which is emitted from the same light source as the information-reproducing light source and which is substantially not absorbed in the recording layer, i.e. as the light for tracking servo-control and/or focusing servo-control in reproducing information from the recording layer of the optical recording medium, so that the breakdown of information recorded on the recording layer can be prevented in tracking servo and/or focusing servo process without providing a new light source for emitting light for tracking and/or focusing. In other words, tracking servo-control and/or focusing servo-control can be done without breakdown of the information recorded on the recording layer.

In the information-reproducing method and device which performs tracking servo-control and/or focusing servo-control, the tracking servo-control of, e.g. a push-pull type or three-beam type heretofore known is feasible and the focusing servo-control by, e.g. a astigmatic method heretofore known is feasible.

Examples of the information-reproducing methods and devices and the optical recording media will be described in more detail with reference to the accompanying drawings.

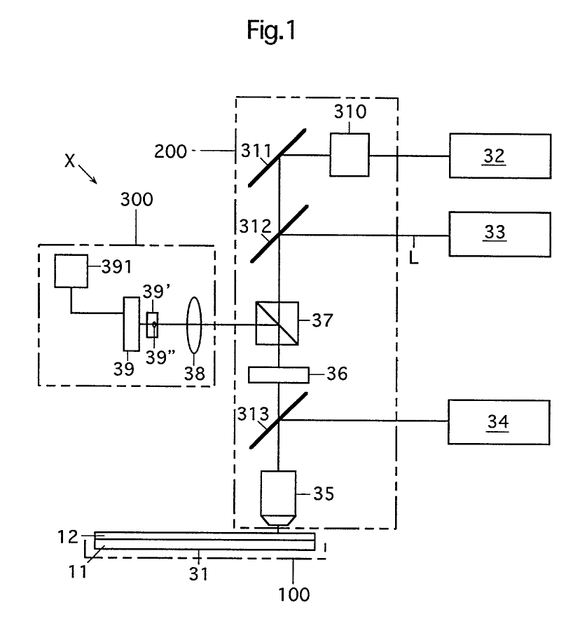

FIG. 1 schematically shows the structure of an apparatus for recording, reproducing and erasing information which includes an example of the information-reproducing device for carrying out the foregoing information-reproducing method wherein an optical recording medium is accommodated.

The information-recording, reproducing and erasing apparatus X which is shown in FIG. 1 is provided with an optical recording medium-accommodating portion 100, an information-recording light source 32, an information-reproducing light source 33, an information-erasing light source 34, an optical system 200 including an information-reproducing optical system, an information reading device 300 and the like and is adapted to reproduce information from an optical recording medium 31 accommodated in the optical recording medium-accommodating portion 100, to record information on the medium 31 and to erase information from the medium 31. Stated more specifically, for recording information, information-recording light is emitted from the recording light source 32 to the recording layer 12 of the optical recording medium 31 based on recording information via the optical system 200 to record the information on the recording layer 12. Namely the information is recorded due to a variation in the refractive index of the recording layer 12. For erasing information, information-erasing light is emitted from the erasing light source 34 to the recording layer 12 via the optical system 200 to erase the information recorded on the recording layer 12. For reproducing information, information-reproducing light L, i.e. light in the region of wavelength which is substantially not absorbed in the recording layer 12, is emitted from the information-reproducing light source 33 to the recording layer 12 via the optical system 200. The information reading device 300 can read the information recorded on the recording layer based on a variation in the refractive index of the recording layer 12, based on a variation in the amount of reflected light from the recording layer 12 by irradiation of the recording layer 12 with the information-reproducing light L.

The optical recording medium-accommodating portion 100 has a rotary driving gear (not shown) and can accommodate the disk-like optical recording medium 31. The optical recording medium 31 is fixed around a rotating spindle(not shown) of the rotary driving gear and can be rotationally driven by the rotary driving gear.

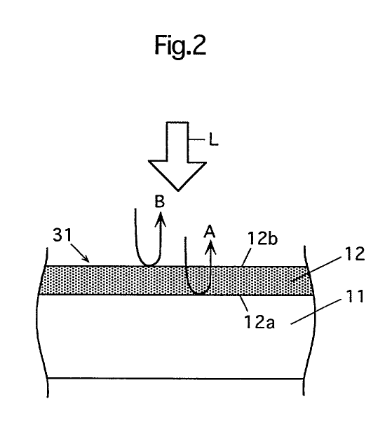

FIG. 2 is a schematic section view partly showing the optical recording medium 31 and depicts the state of reflected light from the optical recording medium 31 by irradiation of the medium with the information-reproducing light L. The letters A and B in FIG. 2 indicate reflected light beams from the optical recording medium 31.

The optical recording medium 31 is a photochromic medium for use in utilizing the photochromic reaction of a photochromic material and has the recording layer 12 containing the photochromic material for recording information over a base plate 11. The optical recording medium 31 allows re-writing information. In the medium 31, any one of the state of ring cleavage and the state of ring closure of photochromic molecules in the recording layer 12 is caused to correspond with an information-unrecorded state (a state wherein information is not recorded) and the other is caused to correspond with an information-recorded state (a state wherein information is recorded). The state of ring cleavage corresponds to the information-recorded state and the state of ring closure corresponds to the information-unrecorded state herein.

The base plate 11 can be formed from, e.g. glass, plastics or the like. The base plate 11 used herein is made of glass.

The recording layer 12 can be formed from spiropyran compounds, diarylethene compounds or like photochromic materials. The recording layer 12 described herein was formed by coating the base plate 11 with a diarylethene compound using a spin coating method.

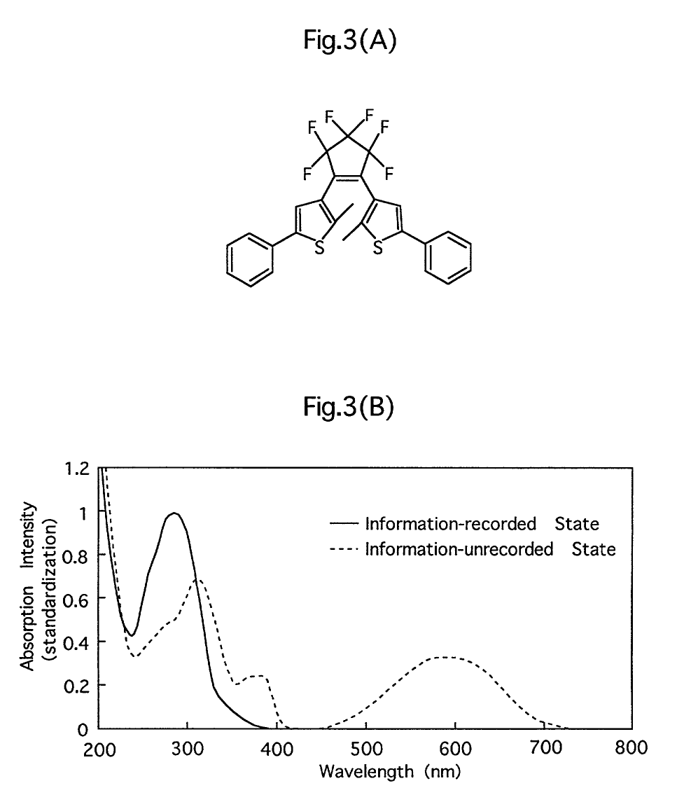

FIG. 3 (A) shows the chemical formula of the photochromic material in the state of ring cleavage to be used for the recording layer 12, and FIG. 3 (B) is a graph showing the absorption intensity (light absorption spectrum) of the photochromic material in the state of ring cleavage (information-recorded state) and in the state of ring closure (information-unrecorded state) to be used for the recording layer 12 with respect to the wavelength of light.

In the optical recording medium 31, a significant variation is brought about in the refractive index of the recording layer 12 between the information-recorded state and the information-unrecorded state by irradiation of the recording layer 12 with light in the region of wavelength (for example, a wavelength of about 780 nm as shown in FIG. 3 (B)) which is approximately on the terminal of long wavelength side of the light absorption terminals in the light absorption spectrum of the recording layer 12, and is substantially not absorbed in the recording layer 12.

If the refractive index of the recording layer 12 is varied, there arises, as shown in FIG. 2, a variation in the state of interference between reflected light beams (B, A in FIG. 2) from an interface 12b on the light-irradiated side of the recording layer 12 and from an interface 12a on the side opposed to the light-irradiated side, whereby the amount of reflected light from the medium is varied depending on the information-recorded state or the information-unrecorded state when the information-reproducing light L is emitted to the recording layer 12. The information can be reproduced according to the difference in the amount of reflected light.

In the optical recording medium 31, the information recorded due to a variation in the refractive index of the recording layer 12 can be reproduced based on a variation in the amount of reflected light from the recording layer 12 by irradiation of the recording layer 12 with, as the information-reproducing light L, light in the region of wavelength substantially not absorbed in the recording layer 12. The information can be reproduced without destruction of the information because the light in the region of wavelength substantially not absorbed in the recording layer 12 is used as the information-reproducing light L.

In accordance with a variation in the thickness of the recording layer 12 in the optical recording medium 31, the reflectance in the information-recorded state or in the information-unrecorded state is varied. Consequently a difference in reflectance between the information-recorded state and the information-unrecorded state depends on the thickness of the recording layer 12. The reflectance is variable according to the thickness of the recording layer due to the effect of interference by multiple reflection. The interference occurs, as shown in FIG. 2, between the reflected light (B in the drawing) from the interface 12b on the information-reproducing light-irradiated side of the recording layer 12 and the reflected light (A in the drawing) from the interface 12a on the side opposed to the light-irradiated side. The larger the amount of the reflected light (amount of the reflected light B) from the interface 12b on the information-reproducing light-irradiated side and the amount of the reflected light (amount of the reflected light A) from the interface 12a on the side opposed to the light-irradiated side, the wider the difference in reflectance between the information-recorded state and the information-unrecorded state.

The recording layer 12 has a thickness (about 120 nm herein) such that the amount of reflected light from the recording layer 12 is the largest or substantially largest due to interference occurring between the reflected light B from the interface 12b on the information-reproducing light-irradiated side of the recording layer 12 and the reflected light A from the interface 12a on the side opposed to the light-irradiated side. Consequently a great difference is brought about in the reflectance between the information-unrecorded state and the information-recorded state, whereby the information is reproduced more easily and more precisely. The amount of reflected light may be large or small due to the effect of interference depending on a relation of magnitude between the refractive index of the recording layer and that of the layer adjacent to the recording layer. In the foregoing embodiment, the thickness of the recording layer was so selected that the largest or substantially largest amount of reflected light was brought about. However, there are cases wherein it is preferred to select the thickness of the recording layer so that the smallest or substantially smallest amount of reflected light is caused. At any rate, the thickness of the recording layer is in a specific range wherein the greatest or substantially greatest difference is made between the amount of reflected light from the recording layer on irradiation of the medium with the information-reproducing light and the amount of reflected light from the medium lacking the recording layer on irradiation of the medium lacking the recording layer with the same light, due to interference occurring between reflected light from the interface on the information-reproducing light-irradiated side of the recording layer and reflected light from the interface on the side opposed to the light-irradiated side.

The information-recording light source 32 shown in FIG. 1 is a He—Ne laser light source from which laser light of 543.5 nm in wavelength can be emitted as the information-recording light toward the optical system 200.

The information-reproducing light source 33 used herein is a semiconductor laser light source from which laser light of 780 nm in wavelength can be emitted as the information-reproducing light L toward the optical system 200. The information-reproducing light L is light having a wavelength in the region which is substantially not absorbed in the recording layer 12.

The information-erasing light source 34 used herein is a mercury lamp light source from which light of 365 nm in wavelength can be emitted as the information-erasing light toward the optical system 200.

The optical system 200 has an AO (acoustic optic) modulator 310, a mirror 311, dichroic mirrors 312, 313, a polarization beam splitter 37, a quarter wave plate 36 and an objective lens 35.

The AO modulator 310 can modulate information-recording light emitted from the laser light source 32.

The mirror 311 is adapted to lead information-recording light from the AO modulator 310 to the dichroic mirror 312.

The dichroic mirror 312 can direct the information-recording light from the mirror 311 and the information-reproducing light L from the information-reproducing light source 33, respectively to the polarization beam splitter 37. The dichroic mirror 312 can reflect 90% or more of light of 620 nm to 800 nm in wavelength and can transmit 90% or more of light of 400 nm to 570 nm in wavelength. Consequently the mirror 312 can reflect virtually the entire amount of information-reproducing light L (light of 780 nm in wavelength) from the light source 33 and can transmit practically the entire amount of information-recording light (light of 543.5 nm in wavelength) from the mirror 311 so that these light beams can be directed to the polarization beam splitter 37.

The polarization beam splitter 37 and the quarter wave plate 36 can transmit the light from the dichroic mirror 312 and is so disposed as to monitor reflected light from the optical recording medium 31. The polarization beam splitter 37 can reflect the light passing from the optical recording medium 31 through the objective lens 35, the dichroic mirror 313 and the quarter wave plate 36 and can lead the same to the information reading device 300.

The dichroic mirror 313 can direct the information-recording light and information-reproducing light L from the quarter wave plate 36 and the information-erasing light from the information-erasing light source 34, respectively to the objective lens 35. Stated more specifically, the dichroic mirror 313 can reflect 80% or more of light of 300 nm to 470 nm in wavelength and can transmit 90% or more of light of 500 nm to 800 nm in wavelength. Namely the mirror 313 can reflect substantially the entire amount of information-erasing light (light of 365 nm in wavelength) from the light source 34, and can transmit substantially the entire amounts of information-recording light (light of 543.5 nm in wavelength) and information-reproducing light L (light of 780 nm in wavelength) from the quarter wave plate 36, directing them to the objective lens 35.

The objective lens 35 can collect the light from the dichroic mirror 313 to direct it to the recording layer 12 of the optical recording medium 31.

The information reading device 300 has a lens 38, a pinhole member 39′, a photo detector 39 and an information processing member 391.

The lens 38 can collect the light from the polarization beam splitter 37 to direct the same to the pinhole member 39′.

The pinhole member 39′ has a pinhole 39″ at a location on which light is incident, and the member 39′ is disposed in front of a light-incident portion (on which light is incident) of the photo detector 39 to give a Reflection type cofocal microscope optical system. Scattering light from the lens 38 can be removed by disposing the pinhole member 39′ in front of the light-incident portion of the photo detector 39 to provide a Reflection type cofocal microscope optical system, whereby the degree of noises in information-reproducing signals can be reduced.

The photo detector 39 can perform photoelectric conversion of the light from the pinhole member 39′. The electric signals obtained by the conversion can be detected as the amount of reflected light from the recording layer 12 of the optical recording medium 31. The information-processing member 391 can read the signals given by the photoelectric conversion in the photo detector 39 as recording information from the recording layer 12. As a consequence, the information recorded on the recording layer 12 due to a variation in the refractive index can be reproduced based on a variation in the amount of reflected light from the recording layer 12 by irradiating the recording layer 12 with light in the region of wavelength emitted as the information-reproducing light L which is substantially not absorbed in the recording layer 12.

In the information-recording, reproducing and erasing apparatus X as described above, the optical recording medium 31 is rotationally driven by the rotary driving gear (not shown) to record, reproduce or erase information on or from the optical recording medium 31.

To record information on the optical recording medium 31, the information-recording light of 543.5 nm in wavelength is emitted from the He—Ne laser light source 32 and is modulated by the AO modulator 310 after which the light is permitted to pass through the optical system including the mirror 311, the dichroic mirror 312, the polarization beam splitter 37, the quarter wave plate 36 and the dichroic mirror 313, is collected by the objective lens 35 and is emitted to the recording layer 12 of the photochromic medium 31 to thereby record the information based on a variation in the refractive index of the recording layer 12.

To erase information from the optical recording medium 31, the information-erasing light is emitted from the mercury lamp light source 34 and is reflected at the dichroic mirror 313 after which the light is collected by the objective lens 35, and is emitted to the recording layer 12 of the photochromic medium 31 to thereby erase the information of the recording layer 12.

To reproduce the information recorded due to a variation in the refractive index of the recording layer 12 in the optical recording medium 31, the information-reproducing light L of 780 nm in wavelength is emitted from the semiconductor laser light source 33 after which the light is permitted to pass through the optical system including the dichroic mirror 312, the polarization beam splitter 37, the quarter wave plate 36 and the dichroic mirror 313, is collected by the objective lens 35 and is directed to the recording layer 12 of the photochromic medium 31. The light reflected at the photochromic medium 31 is permitted to pass again through the objective lens 35, the dichroic mirror 313 and the quarter wave plate 36 after which the light is reflected at the polarization beam splitter 37, and is directed to the photo detector 39 via the lens 38 and the pinhole member 39′ wherein the light is converted to electric signals according to a variation in the amount of light. The electric signals are sent to the information-processing member 391 and are read as recording information. The information-reproducing light L having a wavelength of 780 nm is substantially not absorbed in the recording layer 12 of the photochromic medium 31 (see the light absorption spectrum shown in FIG. 3 (B)).

According to the optical recording medium 31 and the apparatus X having the information-reproducing device for carrying out the method for reproducing information from the optical recording medium which is shown in FIG. 1, the information recorded on the recording layer 12 is not destroyed since the information is reproduced by irradiating the recording layer 12 with light in the region of wavelength which is substantially not absorbed in the recording layer 12 as the information-reproducing light L. The information recorded due to a variation in the refractive index of the recording layer 12 is reproduced based on a variation in the amount of reflected light from the recording layer 12 so that the information-reproducing device is proper in conformability with the conventional means for reproducing information based on a detected amount of reflected light. In short, it is possible to utilize the conventional method for reproducing information based on the amount of reflected light from the recording layer by irradiation with information-reproducing light, and among other things, the information recorded on the recording layer 12 can be reproduced without destruction of the information.

According to the optical recording medium 31, the recording layer 12 has a thickness such that the amount of reflected light from the recording layer 12 on irradiation of the recording layer 12 with the information-reproducing light L is the largest or substantially largest due to interference occurring between reflected light B at an interface 12b on the information-reproducing light-irradiated side of the recording layer 12 and reflected light A at an interface 12a on the side opposed to the light-irradiated side. Thus, it is possible to bring about a large amount of reflected light (amount of reflected light B) from the interface 12b on the information-reproducing light-irradiated side and a large amount of reflected light (amount of reflected light A) from the interface 12a on the side opposed to the information-reproducing light-irradiated side, so that the difference of reflectance can be correspondingly widened between the information-recorded state and the information-unrecorded state.

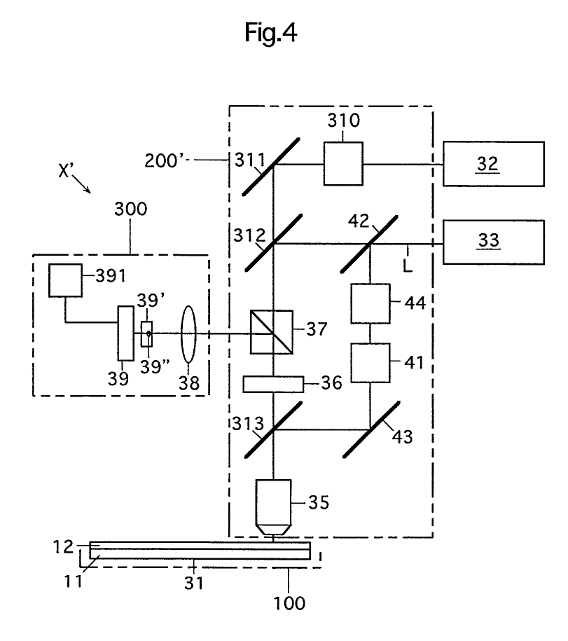

FIG. 4 shows an apparatus modification X′ of the apparatus X for recording, reproducing and erasing information which is shown in FIG. 1.

The apparatus modification X′ shown in FIG. 4 is identical with the apparatus X shown in FIG. 1 except that the information-erasing light source 34 is excluded from the apparatus X and that an optical system 200′ is used in the apparatus modification X′ in place of the optical system 200. Like numerals are used for like and corresponding parts having the same structure and the same function in the apparatuses shown FIGS. 1 and 4. The information-reproducing light source 33 is used also as an information-erasing light source in the apparatus modification X′ as described later. Thus the numeral 33 designates a combined light source for reproducing and erasing information.

The apparatus modification X′ is described below mainly in respect of its differences from the apparatus X shown in FIG. 1.

The apparatus modification X′ shown in FIG. 4 is provided with a portion 100 for accommodating an optical recording medium, an information-recording light source 32, a combined light source 33 for reproducing and erasing information, an optical system 200′ and an information reading device 300. For recording information, the apparatus modification X′ is adapted to record information by emitting information-recording light based on recording information from the information-recording light source 32 via the optical system 200′ for light irradiation of the recording layer 12 of the optical recording medium 31 to thereby record the information on the recording layer 12. For erasing information, the apparatus modification X′ is adapted to erase information by emitting information-erasing light from the combined light source 33 for reproducing and erasing information via the optical system 200′ for light irradiation of the recording layer 12 to thereby erase the information from the recording layer 12. For reproducing information, the apparatus modification X′ is adapted to reproduce information by emitting information-reproducing light L from the combined light source 33 for reproducing and erasing information via the optical system 200′ for light irradiation of the recording layer 12 to thereby reproduce the information from the recording layer 12.

The optical system 200′ has an AO modulator 310, a mirror 311, dichroic mirrors 312, 313, a polarization beam splitter 37, a quarter wave plate 36, an objective lens 35, a half mirror 42, SHG 41 (second harmonic generator formed herein from LiNbO₃), a mirror 43 and a shutter 44. Among them, the AO modulator 310, the mirror 311, the dichroic mirrors 312, 313, the polarization beam splitter 37, the quarter wave plate 36 and the objective lens 35 are identical with the corresponding components of the optical system 200 in the apparatus X shown in FIG. 1. For this reason, description of these parts is omitted herein.

The half mirror 42 is capable of directing part of the laser light L from a semiconductor laser light source 33 used as the combined light source for reproducing and erasing information toward the dichroic mirror 312 and directing its residue toward SHG 41.

SHG 41 can convert light having a wavelength A (light of 780 nm in wavelength) from the half mirror 42 into light of second harmonic having a wavelength λ/2 (light of 390 nm in wavelength) as information-erasing light and can emit the light to the mirror 43.

The mirror 43 can lead the information-erasing light from SHG 41 to the dichroic mirror 313. The shutter 44 is adapted to intercept or pass light which is reflected at the half mirror 42 and which is emitted to SHG 41. The shutter 44 used herein is a solenoid shutter.

In this way, information-erasing light and information-reproducing light L can be emitted from the light source 33 via the optical system 200′.

According to the apparatus modification X′, the optical recording medium 31 is rotationally driven by a rotary driving gear (not shown) in recording information on the optical recording medium 31, or reproducing information from the medium 31 or erasing information on the medium 31.

Recording information on the optical recording medium 31 and reproducing information from the medium 31 are carried out by the apparatus modification X′ in the same manner as by the apparatus shown in FIG. 1 and are not described herein.

When information is erased from the optical recording medium 31, light of 780 nm in wavelength is emitted from the semiconductor laser light source 33, and the shutter 44 is brought into an open state and the light partly reflected at the half mirror 42 is caused to reach SHG 41. After passage through SHG 41, the light having a wavelength of λ (light of 780 nm in wavelength) is converted to light of second harmonic having a wavelength of λ/2 (light of 390 nm in wavelength) serving as information-erasing light. Thereafter the light is reflected at the mirror 43 and the dichroic mirror 313, and is collected by the objective lens 35 for emission to the recording layer 12 in the photochromic medium 31, whereby the information is erased from the recording layer 12.

The apparatus modification X′ shown in FIG. 4 can reduce the number of light sources compared with the information-recording, reproducing and erasing apparatus X shown in FIG. 1 and can advantageously lower the cost.

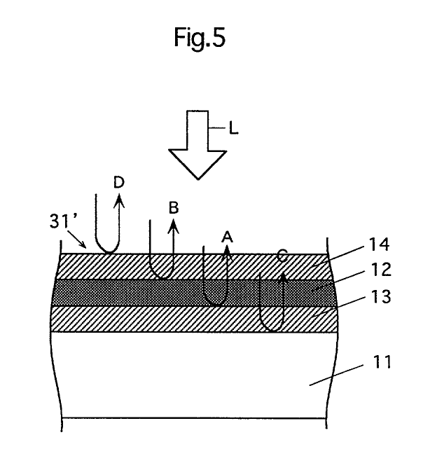

FIG. 5 is a schematic section view partly showing a modification 31′ of the optical recording medium according to the invention and shows the state of reflected light from the optical recording medium 31′ by irradiation of the medium with the information-reproducing light L. In FIG. 5, the letters A, B, C and D indicate reflected light beams from the optical recording medium 31′.

The optical recording medium 31′ shown in FIG. 5 has interference layers 13, 14 which are substantially transparent with respect to the information-reproducing light L emitted to the recording layer 12 containing the photochromic material for recording information, the interference layers 13, 14 having a thickness(each 80 nm herein) of approximately λ(2 m−1)/(4n) wherein λ is the wavelength of the information-reproducing light L, m is an optional integer of 1 or more and n is the refractive index of the interference layers 13, 14, and the interference layers 13, 14 being formed in each position adjacent to the interface of the recording layer 12 on the information-reproducing light-irradiated side of the recording layer 12 and to the interface thereof on the side opposed to the information-reproducing light-irradiated side.

Stated more specifically, the optical recording medium 31′ has the first interference layer 13, the recording layer 12 and the second interference layer 14 formed on the base plate 11. Materials for the base plate 11 and for the recording layer 12 are the same as used in the optical recording medium 31. Like numerals are used for like parts.

As described above, the larger the amount of reflected light at the interface on the information-reproducing light-irradiated side of the recording layer and the amount of reflected light at the interface on the side opposed to the light-irradiated side, the greater the difference in reflectance between the information-unrecorded state and the information-recorded state. From this viewpoint, it is preferred to form the first and second interference layers 13, 14 which widely differ in the refractive index from the recording layer 12. Thus, preferred interference layers are those formed from a material of high refractive index, e.g. at least one material selected from TiO₂, ZrO₂, ZnS, PbCl₂, Ta₂O₅, SiN, DLC (diamond like carbon), SiC, GaP, SiGe and GaAs to which, however, the material is not limited. Alternatively a material of low refractive index, e.g. about 1.3 in refractive index, such as MgF₂ and Na₃AlF₆, can also be used for the first and second interference layers 13, 14. The first and second interference layers 13, 14 used herein are those formed from TiO₂ by a sputtering method. Of course, different materials can be used for the first and second interference layer 13 and 14, respectively.

In the optical recording medium 31′ shown in FIG. 5, the interference layers 13, 14 provided therein are substantially transparent with respect to the information-reproducing light L, the interference layers 13, 14 having a thickness of approximately λ(2 m−1)/(4n) and the interference layers 13, 14 being formed in a position adjacent to the interface on the information-reproducing light-irradiated side of the recording layer 12 and the interface on the side opposed to the information-reproducing light-irradiated side so that a great difference can be made in the amount of reflected light between the information-recorded state and the information-unrecorded state in the recording layer 12.

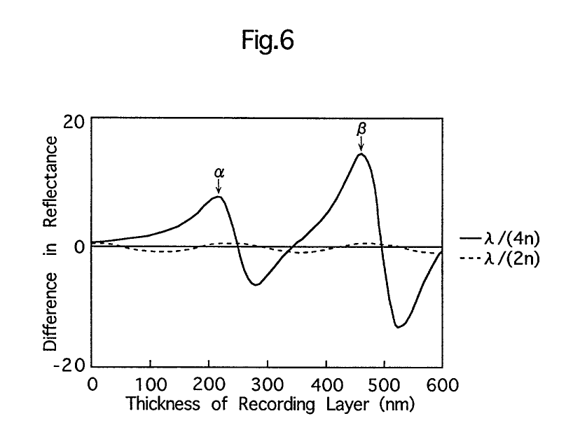

FIG. 6 is a graph showing the dependence, on the thickness of the recording layer 12, of a difference in the reflectance between the information-recorded state and the information-unrecorded state in the recording layer 12 when the recording layer 12 is irradiated with the information-reproducing light L and the first interference layer 13 and the second interference layer 14 both have a thickness of λ(2 m−1)/(4n) wherein m is 1, or λ/(2n).

When the thicknesses of interference layers 13, 14 are λ/(4n), the variation in the amount of reflected light can be increased based on a variation in the refractive index of the recording layer 12 due to effects of interference between reflected light C and reflected light A and interference between reflected light D and reflected light B in addition to interference between reflected light A and reflected light B, as shown in FIG. 5. On the other hand, when the thicknesses of interference layers 13, 14 are λ/(2n), the interference layers 13, 14 do not exist in appearance, and the effects by the formation of interference layers 13, 14 can not be expected. Therefore it is desirable to form the first and second interference layers 13, 14 having a thickness of approximately λ(2 m−1)/(4n).

In the optical recording medium 31′, the interference layers 13, 14 are formed in positions adjacent to the two interfaces of the recording layer 12. The interference layer, however, may be formed in a position adjacent to any one of the two interfaces.

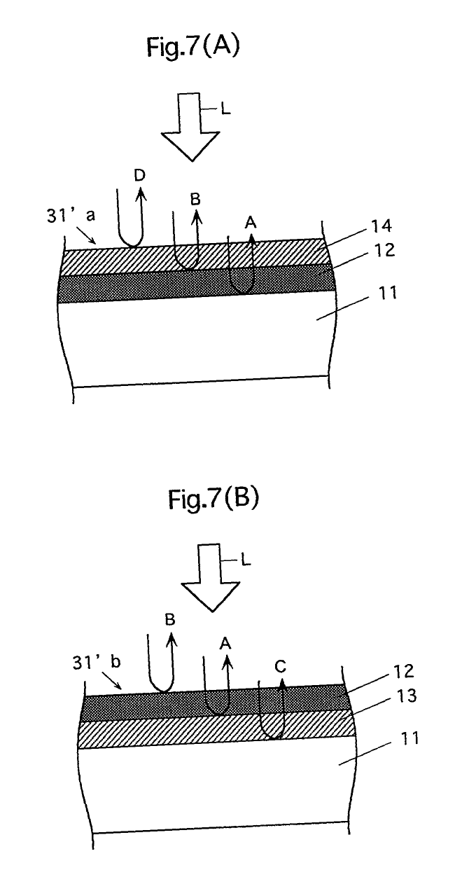

FIG. 7 (A) shows a photochromic medium 31′a having an interference layer 14 provided only at the interface on the information-reproducing light-irradiated side of the recording layer 12, and FIG. 7 (B) shows a photochromic medium 31∝b having an interference layer 13 provided only at the interface on the side opposed to the information-reproducing light-irradiated side of the recording layer 12.

The variation in the amount of reflected light can be increased based on a variation in the refractive index of the recording layer 12 due to effects of interference between reflected light D and reflected light B as well as interference between reflected light A and reflected light B in the photochromic medium 31′ shown in FIG. 7 (A), or due to effects of interference between reflected light C and reflected light A as well as interference between reflected light A and reflected light B in the photochromic medium 31′ shown in FIG. 7 (B).

An embodiment is possible wherein an interference layer may be formed in a position adjacent to any one of two interfaces of the recording layer and a metallic layer may be provided in a position adjacent to an interface on the side of the recording layer on which the interference layer is absent.

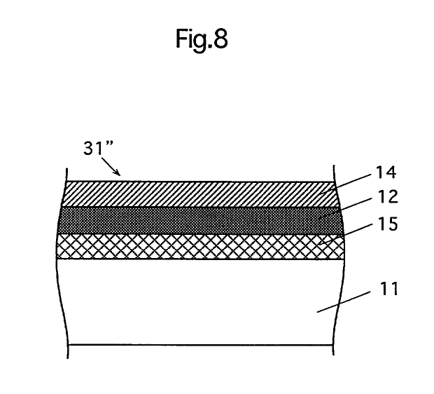

FIG. 8 is a schematic section view partly showing a further modification 31″ of the optical recording medium. The optical recording medium 31″ shown in FIG. 8 comprises a base plate 11, a metallic layer 15, and a recording layer 12 containing a photochromic material for recording information and an interference layer 14 formed on the base plate 11,. Materials for the base plate 11 and for the recording layer 12 are the same as in the optical recording medium 31, and materials for the interference layer 14 are the same as in the optical recording medium 31′. Like numerals are used for like and corresponding parts.

Examples of materials for the metallic layer 15 are metals, alloys, metallic compounds and the like. The material for the metallic layer 15 used herein is metal. The metallic layer can be formed by a sputtering method, a vacuum deposition method or the like. The metallic layer 15 was formed herein by a sputtering method, and has a thickness of 20 nm.

The optical recording medium 31″ shown in FIG. 8 has the same advantages as the optical recording media shown in FIGS. 5, 7(A) and 7(B).

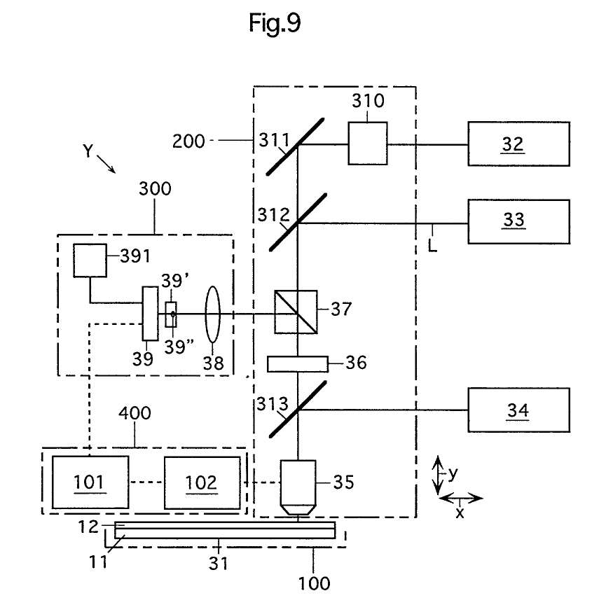

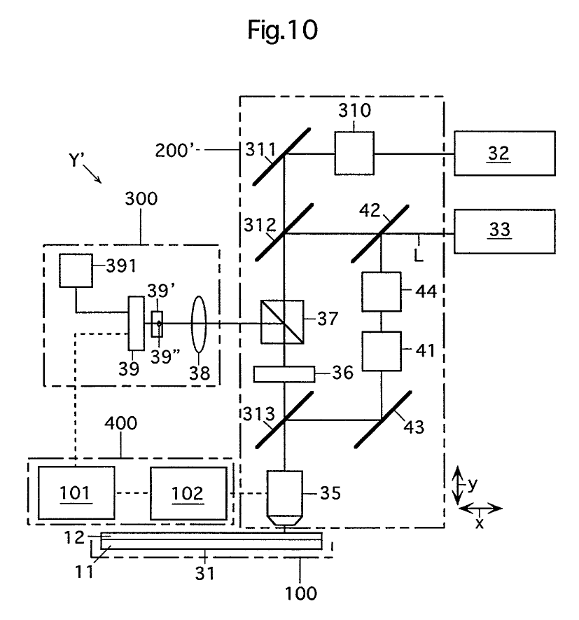

FIGS. 9 and 10 show other apparatus modifications Y, Y′ of the apparatus for recording, reproducing and erasing information X, X′, respectively shown in FIGS. 1 and 4.

The apparatus modifications Y, Y′ shown in FIGS. 9 and 10 are identical with the apparatus X, X′ for recording, reproducing and erasing information shown in FIGS. 1 and 4 except that the apparatus modifications Y, Y′ have a servo device 400 for conducting tracking servo-control for tracking the medium and/or focusing servo-control for focusing on the medium. Like numerals are used for like parts of the apparatus modifications Y, Y′ having the same structure and the same function as the apparatus X, X′.

The apparatus modifications Y, Y′ are described below mainly concerning their differences from the apparatus X, X′ shown in FIGS. 1 and 4.

In the apparatus modifications Y, Y′ shown in FIGS. 9 and 10, the servo device 400 is adapted to conduct tracking servo-control and/or focusing servo-control using light in the region of wavelength which is emitted from the same light source as the information-reproducing light source 33 and which is substantially not absorbed in the recording layer 12 as the light for tracking and/or focusing when the information recorded on the recording layer 12 of the optical recording medium 31 due to a variation of the refractive index is reproduced based on a variation in the amount of reflected light from the recording layer 12 by irradiating the recording layer 12 with information-reproducing light L emitted from the information-reproducing light source 33 via the optical system 200 or 200′.

A photo detector 39 used herein has a four-divided photodiode and can perform photoelectric conversion of the light from a pinhole member 39′ to servo signals using 4 detection sensors and can send the servo signals to the servo device 400.

The servo device 400 has a servo circuit 101, and a driving gear 102 for servo-control.

The driving gear 102 is connected to the servo circuit 101 and can drive the objective lens 35 in a tracking direction (x direction in the drawing) and/or in a focusing direction (y direction in the drawing) according to the instructions from the servo circuit 101.

The servo circuit 101 can control the position of the objective lens 35 in the tracking direction x and/or in the focusing direction y with the driving gear 102 according to the servo signals from the photo detector 39.

The servo device 400 can perform tracking servo-control, e.g. by the push-pull type or three-beam type method heretofore known and can effect focusing servo-control by e.g., the astigmatic method heretofore known. In the embodiments described herein, tracking servo-control by the push-pull type method is conducted and/or focusing servo-control by the astigmatic method is done.

The apparatus modifications Y, Y′ are adapted to record information on the optical recording medium 31, to reproduce information from the medium 31 and to erase information on the medium 31 in the same manner as the apparatus shown in FIGS. 1 and 4. Accordingly description on this matter is omitted.

In reproducing information from the optical recording medium 31, tracking and/or focusing is carried out.

Stated more specifically, light in the region of wavelength (light of 780 nm in wavelength) which is substantially not absorbed in the recording layer 12 is emitted as the light for servo-control from the semiconductor laser light source 33 (the same light source as the information-reproducing light source for emitting information-reproducing light L). Then the light is allowed to pass through the optical system in the apparatus modification Y including a dichroic mirror 312, a polarization beam splitter 37, a quarter wave plate 36, and a dichroic mirror 313, or through the optical system in the apparatus modification Y′ including a half mirror 42, a dichroic mirror 312, a polarization beam splitter 37, a quarter wave plate 36 and a dichroic mirror 313. Thereafter the light is collected by the objective lens 35 and is emitted to the recording layer 12 of the photochromic medium 31. The light reflected at the photochromic medium 31 is permitted to pass again through the objective lens 35, the dichroic mirror 313 and the quarter wave plate 36, is reflected at the polarization beam splitter 37, is emitted via the lens 38 and the pinhole member 39′ to the photo detector 39, and is converted by the photo detector 39 to electric signals as servo signals. The servo signals are input into the servo circuit 101 and drive the objective lens 35 with the driving gear 102 according to control output from the servo circuit 101. The light for servo-control having a wavelength of 780 nm is substantially not absorbed in the recording layer 12 of the photochromic medium 31 (see light absorption spectrum shown in FIG. 3 (B)).

In the apparatus modifications Y, Y′, the servo device 400 is adapted to effect tracking servo-control and/or focusing servo-control using, as light for tracking servo-control and/or focusing servo-control, light in the region of wavelength which is emitted from the same light source as the information-reproducing light source 33 and which is substantially not absorbed in the recording layer 12 when information is reproduced from the recording layer 12 of the optical recording medium 31 so that the destruction of the information recorded on the recording layer 12 can be prevented in tracking servo and/or focusing servo process without using a new light source for emitting light for tracking and/or focusing. Consequently tracking servo-control and/or focusing servo-control can be done without destruction of the information recorded on the recording layer 12.

Experiments were carried out using optical recording media with recording layers varied in the thickness in such way that the information recorded due to a variation in the refractive index of the recording layer is reproduced based on a variation in the amount of reflected light. The experiments are described below.

### (Experiment Example 1)

In this experiment, the optical recording medium 31 shown in FIG. 2 with a recording layer 12 of varied thicknesses (20 nm, 50 nm, 70 nm, 110 nm, 150 nm or 220 nm) was accommodated in the information-recording, reproducing and erasing apparatus X shown in FIG. 1. Then, information-recording light, information-erasing light and information-reproducing light were emitted toward the side of the recording layer 12 to record, erase or reproduce the information on or from the medium 31. The reflectance of the recording layer 12 in an information-recorded state and in an information-unrecorded state was measured by irradiation of the recording layer 12 with the information-reproducing light L.

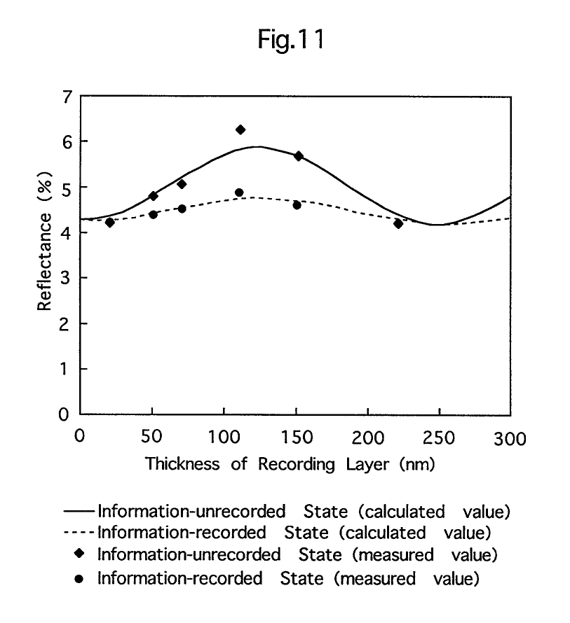

The results of the experiment are shown in FIG. 11. FIG. 11 is a graph showing the results of measuring the reflectance of the recording layer 12 in the information-recorded state and in the information-unrecorded state with respect to the thickness of the recording layer 12 and the results of calculation from a logical equation of multiple reflection in a thin film. A mark ♦ in the drawing shows a measured value of the reflectance in the information-unrecorded state; a mark ● shows a measured value of the reflectance in the information-recorded state; a solid line indicates a calculated value of the reflectance in the information-unrecorded state; and a broken line indicates a calculated value of the reflectance in the information-recorded state.

As shown in FIG. 11, it is clear that the reflectance values in the information-unrecorded state and the information-recorded state are varied with a variation in the thickness of the recording layer 12, and that a difference of reflectance between the information-unrecorded state and the information-recorded state is dependent on the thickness of the recording layer 12.

As already described, the reflectance is varied with the thickness of the recording layer due to the effect of interference by multiple reflection. The interference occurs between the reflected light A and the reflected light B as shown in FIG. 2. The more the amount of reflected light A and the amount of reflected light B, the greater the difference in reflectance between the information-unrecorded state and the information-recorded state.

The greatest difference of the reflectance in the results of FIG. 11 is at the thickness of about 120 nm of the recording layer at which the reflectance is about 6% in the information-unrecorded state and about 4.7% in the information-recorded state. This means that the difference in the reflectance therebetween is about 1.3%. Although this difference in the reflectance is small, the recorded information is unlikely to break down in reproduction of information because the information-reproducing light used in this experiment is not absorbed in the recording layer, so that intensive information-reproducing light can be used, making it possible to bring about a difference in the amount of reflected light which is sufficient to reproduce information.

### (Experiment Example 2)

In this experiment, the optical recording media 31′ shown in FIG. 5 with a recording layer 12 of varied thicknesses (220 nm or 460 nm) and the optical recording medium 31′a shown in FIG. 7 (A) with a recording layer 12 of 120 nm in thickness were accommodated in the information-recording, reproducing and erasing apparatus X shown in FIG. 1 respectively. Then, information-recording light, information-erasing light and information-reproducing light were emitted toward the side of the recording layer 12 to record, erase or reproduce information on or from the medium 31′. The reflectance of the recording layer 12 in an information-recorded state and in an information-unrecorded state was measured by irradiation of the recording layer 12 with the information-reproducing light L. Interference layers 13, 14 formed of TiO₂ had a thickness of 80 nm, respectively.

The reflectance was measured using a photochromic medium 31′ comprising an interference layer 14 composed of TiO₂ (80 nm in thickness), a recording layer 12 (220 nm in thickness), an interference layer 13 composed of TiO₂ (80 nm in thickness) and a glass base plate 11 superposed in this order on each other. The reflectance was about 20% in an information-unrecorded state and about 28% in an information-recorded state. This means that a difference in reflectance was about 8% and in other words, i.e. a greater difference than the results of Experiment Example 1 was brought about. The thickness of 220 nm of the recording layer 12 corresponds with the peak α in FIG. 6.

The reflectance was measured using a photochromic medium 31′ comprising an interference layer 14 composed of TiO₂ (80 nm in thickness), a recording layer 12 (460 nm in thickness), an interference layer 13 formed of TiO₂ (80 nm in thickness) and a glass base plate 11 superposed in this order on each other. The reflectance was about 22% in an information-unrecorded state and about 37% in an information-recorded state. This means that a difference in reflectance was about 15%, i.e. a greater difference than in the above case, was brought about. The thickness of 460 nm of the recording layer 12 corresponds with the peak β in FIG. 6.

The reflectance was measured using a photochromic medium 31′a comprising an interference layer 14 composed of TiO₂ (80 nm in thickness), a recording layer 12 (120 nm in thickness) and a glass base plate 11 superposed in this order on each other (FIG. 7 (A)). The reflectance was about 29% in an information-unrecorded state and about 32% in an information-recorded state. This means that a difference of about 3% in reflectance, i.e. a greater difference than the results of Experiment Example 1, was brought about. It is clear that the effect of interference was given.

### (Experiment Example 3)

In this experiment, an optical recording medium 31″ shown in FIG. 8 with a recording layer 12 of varied thicknesses (220 nm or 200 nm) was accommodated in the information-recording, reproducing and erasing apparatus X shown in FIG. 1. Information-recording light, information-erasing light and information-reproducing light were emitted toward the side of the recording layer 12 to record, erase or reproduce the information on or from the medium 31″. The reflectance of the recording layer 12 in an information-recorded state and in an information-unrecorded state was measured by irradiation of the recording layer 12 with the information-reproducing light L. When the recording layer 12 was 220 nm (or 200 nm) in thickness, a metallic layer formed of Al (or Au) was provided as the metallic layer 15 having a thickness of 20 nm. An interference layer 14 composed of TiO₂ had a thickness of 80 nm.

The reflectance was measured using a photochromic medium 31″ comprising an interference layer 14 composed of TiO₂ (80 nm in thickness), a recording layer 12 (220 nm in thickness), a metallic layer 15 formed of Al (20 nm in thickness) and a glass base plate 11 superposed in this order on each other. The reflectance was about 30% in an information-unrecorded state and about 42% in an information-recorded state. This means that a difference in reflectance was about 12%, i.e. a markedly greater difference than the results of Experiment Example 1, was brought about.

The reflectance was measured using a photochromic medium 31″ comprising an interference layer 14 composed of TiO₂ (80 nm in thickness), a recording layer 12 (200 nm in thickness), a metallic layer 15 formed of Au (20 nm in thickness) and a glass base plate 11 superposed in this order on each other. The reflectance was about 18% in an information-unrecorded state and about 29% in an information-recorded state. This means that a difference in reflectance was about 11%, i.e. a significantly greater difference than the results of Experiment Example 1, was brought about.

A great difference in the amount of reflected light resulted from the use of the photochromic medium having the interference layer in a position adjacent to the interface on one side of the recording layer and the metallic layer in a position adjacent to the interface on the side of the recording layer wherein an interference layer was not formed.

While the investigation was made as to the formation of metallic layers formed of Al and Au, respectively, the same results can be acquired by provision of metallic layers formed of Cu and Ag, respectively.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method for reproducing information from an optical recording medium, the method comprising the steps of:
providing an optical recording medium having a recording layer containing a photochromic material on which information can be recorded due to a variation in an optical property of the photochromic material,
irradiating the optical recording medium with information-reproducing light in the region of wavelength which is substantially not absorbed in said recording layer, and
reproducing information based on the result of detecting the amount of said information-reproducing light reflected from said optical recording medium.

2. The method according to claim 1, wherein a tracking servo-control for tracking said optical recording medium is conducted using said information-reproducing light.

3. The method according to claim 1, wherein focusing servo-control for focusing on said optical recording medium is conducted using said information-reproducing light.

4. A device for reproducing information from an optical recording medium, the device comprising:
a portion for accommodating an optical recording medium having a recording layer containing a photochromic material on which information can be recorded due to a variation in an optical property of the photochromic material,
an information-reproducing light source for emitting information-reproducing light in the region of wavelength which is substantially not absorbed in said recording layer,
an optical system for reproducing information which is adapted to irradiate with said information-reproducing light said optical recording medium accommodated in said optical recording medium-accommodating portion, and
an information reading device for reproducing information based on the result of detecting the amount of said information-reproducing light reflected from said optical recording medium.

5. The device according to claim 4 which has a servo device for tracking said optical recording medium using said information-reproducing light.

6. The device according to claim 4 which has a servo device for focusing on said optical recording medium using said information-reproducing light.

7. An optical recording medium having a recording layer containing a photochromic material for recording information, wherein a thickness of said recording layer is in a specific range such that the greatest or substantially greatest difference is made between the amount of reflected light from said recording layer by irradiating the medium with information-reproducing light and the amount of reflected light from the medium wherein said recording layer is not present by irradiating the medium without the recording layer with said information-reproducing light, due to interference occurring between reflected light from an interface on the information-reproducing light-irradiated side of said recording layer and reflected light from an interface on the side opposed to the light-irradiated side.

8. An optical recording medium having a recording layer containing a photochromic material for recording information, wherein an interference layer is provided, and said interference layer is substantially transparent with respect to an information-reproducing light emitted to said recording layer, said interference layer having a thickness of approximately λ(2 m−1)/(4n) wherein λ is the wavelength of said information-reproducing light, m is an optional integer of 1 or more and n is the refractive index of the interference layer, and said interference layer being formed in a position adjacent to at least one of an interface on the information-reproducing light-irradiated side of said recording layer and an interface on the side opposed to the light-irradiated side.

9. The optical recording medium according to claim 8, wherein said interference layer is provided in each of positions adjacent to the two interfaces of said recording layer.

10. The optical recording medium according to claim 8, wherein said interference layer is provided in the position adjacent to any one of the interfaces of said recording layer and a metallic layer is provided in the position adjacent to the interface on the side of said recording layer on which said interference layer is not formed.

11. The optical recording medium according to claim 8, wherein said interference layer is one formed from a material or materials of high refractive index.
